(19) United States
(12) Patent Application Publication
(10) Pub. No.: US 2022/0229655 A1
(43) Pub. Date: Jul. 21, 2022

(54) REMOTE UPDATE OF DEVICES

(71) Applicant: Telefonaktiebolaget LM Ericsson (publ), Stockholm (SE)

(72) Inventor: Joachim Ramkull, Lund (SE)

(21) Appl. No.: 17/614,759

(22) PCT Filed: May 29, 2019
(86) PCT No.: PCT/EP2019/064058

§ 371 Date: Nov. 29, 2021

(51) Int. Cl. G06F 8/65; G06F 11/14; H04W 4/30; H04W 4/80

(52) U.S. Cl. CPC G06F 8/65; H04W 4/80; H04W 4/30; G06F 11/1433

(57) ABSTRACT

A method for remotely updating a plurality of devices wherein the plurality of devices form a distributed system for memory usage is disclosed. The method comprises receiving, at a first device of the plurality of devices, a software package for an update from a remote unit, obtaining, by the first device, information to store one or more local portions of a software image locally in the first device wherein the one or more local portions each comprises a defined portion of a current version of software executing in the first device, and storing, in the first device, the one or more local portions of the software image in memory. Additional related methods are also disclosed. Corresponding computer program product and apparatus are also disclosed.

### TECHNICAL FIELD

The present disclosure relates generally to the field of remote update of devices. More particularly, it relates to remote update of a plurality of devices wherein the plurality of devices form a distributed system for memory usage.

### BACKGROUND

At remote update of a device, e.g. software update, the device may store the previous version installed in the device for rollback purposes e.g. if the update fails.

A drawback of storing the previous version in the device is that the previous version requires a substantial amount of memory which cannot be used for other purposes.

For devices with limited memory capacity, e.g. Internet of Things (IoT) devices, this substantial amount of occupied memory poses a problem.

Another drawback of storing the previous version in the device is that the memory for storing the previous version must be sized to accommodate rollback of e.g. software of increasing size until the update of the device is no longer supported.

Since a new version of e.g. software is usually larger than the previous, increasing memory capacity is required to handle rollback of the previous version.

Therefore, there is a need for alternative approaches for remote update of devices.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

According to a first aspect, this is achieved by a method for remotely updating a plurality of devices wherein the plurality of devices form a distributed system for memory usage.

The method comprises receiving, at a first device of the plurality of devices, a software package for an update from a remote unit, and obtaining, by the first device, information to store one or more local portions of a software image locally in the first device wherein the one or more local portions each comprises a defined portion of a current version of software executing in the first device.

The method further comprises storing, in the first device, the one or more local portions of the software image in memory.

In some embodiments, the method further comprises performing an attempt to install the received software package in the first device to implement the update, and when the update fails, performing rollback to the software image based on the one or more local portions of the software image stored in the first device and one or more remaining portion of the software image by requesting the one or more remaining portion of the software image from one or more second devices of the plurality of devices and reinstalling a re-assembled software image in the first device.

In some embodiments, the method further comprises authenticating, by the first device, the one or more second devices comprising the one or more remaining portion of the software image.

In some embodiments, the method further comprises requesting, by the first device, the one or more remaining portion of the software image from the one or more second devices comprising the one or more remaining portion of the software image when the authentication is successful.

In some embodiments, the method further comprises confirming successful installation to the remote unit when the installation attempt of the software package succeeded, or confirming installation failure and rollback to the remote unit when the installation attempt of the software package failed and rollback was performed.

In some embodiments, the requesting of the one or more remaining portion of the software image from the one or more second devices may be sequential so that the one or more remaining portion are requested sequentially per second device from the plurality of devices or broadcasted so that the one or more remaining portion are requested from the one or more second devices at the same time from the plurality of devices.

In some embodiments, at least one device of the plurality of devices acts as a relay node for transmission of signals to and from at least one device of the plurality of devices.

In some embodiments, the at least one device of the plurality of devices comprises any one of an Internet of Things device, a sensor, and a WiFi hotspot.

In some embodiments, the devices in the distributed system communicate with each other over a short-range wireless communication protocol or a wired connection.

A second aspect is a method for remotely updating a plurality of devices wherein the plurality of devices form a distributed system for memory usage.

The method comprises selecting a group of devices for an update wherein the devices in the group each comprise a software image of a same current version of software executing in the devices, and determining one or more local portions of the software image for a device of the group to store in memory.

The method further comprises transmitting a signal to the device comprising information about the one or more local portions of the software image to store, and executing the determining and the transmitting steps for each device in the group of devices.

In some embodiments, the selecting, determining, and transmitting steps are performed by a remote unit.

In some embodiments, the selecting, determining and transmitting steps are performed by a device of the distributed system.

In some embodiments, the selecting of the group of devices further comprises selecting devices of same or of different type comprising the same current version of software executing in the devices and wherein the devices are capable of communicating with each other.

In some embodiments, the one or more local portions of the software image comprises a portion of a binary image installed in the memory of the device.

In some embodiments, the portion of the binary image is a coherent or a non-coherent portion in memory.

In some embodiments, the signal comprises information about the local portion of the software image to store further comprises information about the one or more remaining portion of the software image and their storage in the distributed system.

In some embodiments, the determining of the local portion of the software image to be stored further comprises assessing available memory in each device of the distributed system.

In some embodiments, the group of devices comprises at least two devices with the same current version of software executing in the devices and capable of communicating with each other.

In some embodiments, the remote unit comprises a host or a host comprising a server.

In some embodiments, the host and at least one device in the distributed system communicate with each other over a long-range wireless communication protocol or a wired connection.

In some embodiments, the second aspect further comprises one or more features as described for the first aspect.

In some embodiments, the first aspect further comprises one or more features as described for the second aspect.

A third aspect is a computer program product comprising a non-transitory computer readable medium, having thereon a computer program comprising program instructions. The computer program is loadable into a data processing unit and configured to cause execution of the method according to the first and/or second aspect when the computer program is run by the data processing unit.

A fourth aspect is an apparatus configured for remotely updating a plurality of devices wherein the plurality of devices form a distributed system for memory usage.

The apparatus comprises controlling circuitry configured to cause selection of a group of devices for an update wherein the devices in the group comprise a software image of a same current version of software executing in the devices, and determination of a respective local portion of the software image for each of the devices of the group to store in memory.

The controlling circuitry is further configured to cause transmission of a signal to each of the devices of the group comprising information about the local respective portion of the software image.

A fifth aspect is a first device configured for remote updating wherein the first device forms part of a distributed system for memory usage.

The first device comprises controlling circuitry configured to cause reception of a software package for an update from a remote unit, and obtainment of information to store one or more local portions of a software image locally in the first device wherein the one or more local portions each comprises a defined portion of a current version of software executing in the first device.

The controlling circuitry is further configured to cause storage of the one or more local portions of the software image in memory.

In some embodiments, any of the above aspects may additionally have features identical with or corresponding to any of the various features as explained above for any of the other aspects.

An advantage of some embodiments is that alternative approaches for remote update of devices are provided.

Another advantage of some embodiments is that when applying the resource-saving update approach, less memory capacity is required in a device for storing the previous version for roll-back purposes.

Yet an advantage of some embodiments is that, even if the size of the update, i.e. the software package to be installed, grows over time, the device can still manage the storing of the previous version for roll-back purposes without increasing the memory capacity of the device and more devices, if possible, may be involved in the storing of the previous version.

Yet another advantage of some embodiments is that a secure distributed system for memory usage is provided.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a sequence diagram illustrating example signaling steps according to some embodiments,

FIG. 3 is a schematic overview illustrating an example system according to some embodiments,

FIG. 4 is a schematic block diagram illustrating example apparatuses according to some embodiments; and

FIG. 5 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As mentioned above, at remote update of a device, the device may store the previous version (e.g., software) installed in the device for rollback purposes if the update fails.

An example of a remote update of a device may comprise storing the previous version installed in the device and also be able to receive and store an update package which likely increases in size for each new version.

In the event that the device has not stored the previous version installed in the device at installation of an update wherein the installation attempt fails, the device may be able to download the previous version from a remote unit. However, this would require network resources as well as power from the network and may be both energy and time consuming for both network and device and especially so if several devices fail the installation attempt.

Current protocols and standards relating to Long Term Evolution (LTE), Internet of Things (IoT), Bluetooth Low Energy (BLE), Narrowband IoT, Radio Resource Control (RRC), and/or 5G/New Radio (NR) do not provide any mechanism to overcome above-mentioned drawbacks.

In the following, embodiments where alternative approaches for remote update of devices are described.

A remote update of a device may comprise update of any one of software, firmware, and data etc. Hereinafter only the term ‘update’ will be used for consistency.

A software package may comprise a package of any one of software, firmware, and data. Hereinafter only the term ‘software package’ will be used for consistency.

A device for remote update may comprise any one of an IoT device, a sensor, and a WiFi hotspot. Hereinafter only the term ‘device’ will be used for consistency.

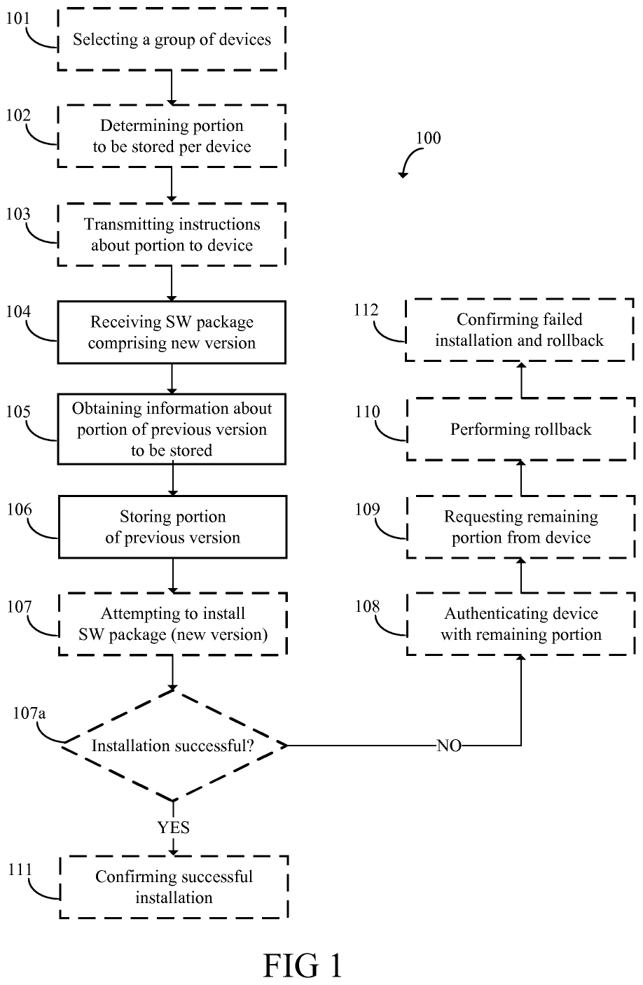

FIG. 1 is a flowchart illustrating method steps of an example method 100 according to some embodiments. The method 100 is for remotely updating a plurality of devices wherein the plurality of devices form a distributed system for memory usage.

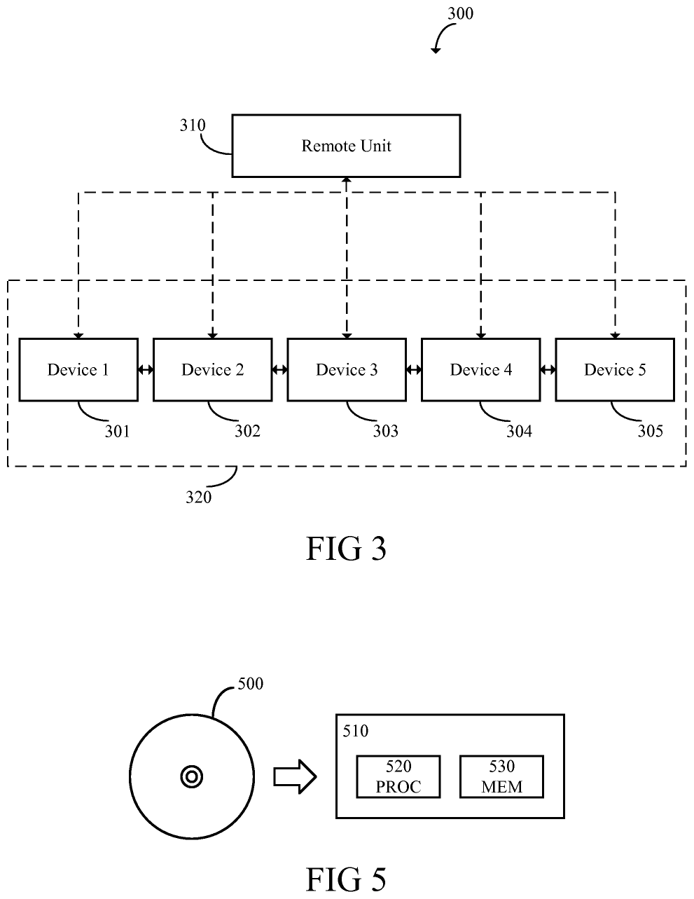

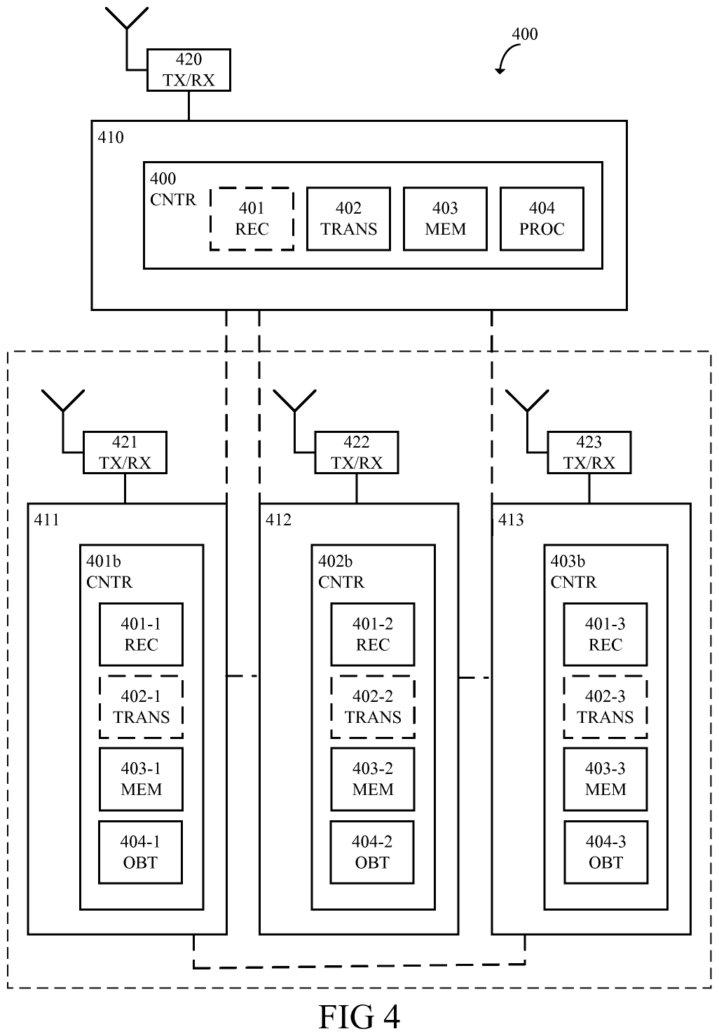

Thus, the method 100 may, for example, be performed by the system 300 of FIG. 3 and/or the apparatuses 400 of FIG. 4 and/or the computer program product 500 of FIG. 5.

For example, steps 101, 102, 103 may be performed by a remote unit or by a device of the plurality of devices, and steps 104, 105, 106, 107, 107a, 108, 109, 110, 111, 112 may be performed by one or more devices of the plurality of devices.

The method 100 comprises following steps.

In step 101, in some embodiments, a group of devices is selected for an update wherein the devices in the group each comprise a software image of a same current version of software executing in the devices.

For example, a group of related devices may be selected for an update wherein the related devices comprise a same current version of software executing in the devices and wherein the related devices are capable of communicating with each other, either via a host protocol or another protocol interconnecting the related devices, e.g. BLE or any wireless communication protocol or even a wired connection.

In step 102, in some embodiments, one or more local portions of the software image is determined for a device of the group to store in memory.

For example, the one or more local portions of the software image may be determined according to a pre-determined scheme by a remote unit, i.e. controlled by the remote unit, or by the devices themselves, i.e. controlled autonomously by the related devices, e.g. five related devices may share the storing of the software image amongst them and hence only store a fifth, i.e. ⅕, of the software image per device according to the pre-determined scheme. Further, the pre-determined scheme in addition to determining the size of the local portion of the software image for each device to store also comprises determining what part of the software image each device should store.

Alternatively or additionally, the one or more local portions of the software image may, for example, be determined according to a negotiation process between the remote unit and the devices or between the devices themselves based on e.g. the memory capacity available in each device. Further, the negotiation process in addition to determining the size of the local portion of the software image for each device to store also comprises determining what part of the software image each device should store.

Alternatively or additionally, the one or more local portions of the software image may, for example, be determined according to a pre-configuration in the devices wherein the pre-configuration comprises information for the device to store one or more local portions of the software image wherein the related devices each have a corresponding pre-configuration. The pre-configuration for the related devices may be known amongst them e.g. device #1 being configured to store local portion #1 is aware that device #2 is configured to store local portion #2 either via signaling or via the pre-configuration etc.

Alternatively or additionally, an overview (i.e. a scheme) of software packages, versions of software executing in the devices, portions of software images, history of installation attempts may be comprised and maintained in the remote unit.

In step 103, in some embodiments, a signal is transmitted to the device comprising information about the one or more local portions of the software image to store.

For example, when the one or more local portions of the software image has been determined by the remote unit or by another device of the related devices i.e. determined by another entity than the device itself then a signal comprising information about the one or more local portions of the software image is transmitted to the device for informing the device about the one or more local portions of the software image to store.

In step 104, a software package is received at a first device of a plurality of devices, for an update from a remote unit.

The update may comprise an update over-the-air (OTA) according to the Open Mobile Alliance (OMA).

For example, the software package may comprise a new version of the software executing in the device i.e. a software update or a firmware update or a data update.

In step 105, information to store one or more local portions of a software image locally in the first device is obtained by the first device wherein the one or more local portions each comprises a defined portion of a current version of software executing in the first device.

For example, the information to store one or more local portions of the software image may, for example, be information indicative of the memory location of the one or more local portions and/or indicative of an instruction to store the one or more local portions at a certain memory location locally in the device.

For example, the obtaining may comprise, in the case of a pre-determined scheme or a negotiation process, receiving a signal from a remote unit or a related device comprising information regarding the one or more local portions of the software image. Further, in the case of a pre-configuration, the obtaining may comprise retrieving pre-configured information regarding the one or more local portions of the software image from one or more memory locations locally in the device.

In step 106, the one or more local portions of the software image is stored in memory of the first device.

For example, the one or more local portions of the software image may comprise one or more local portions of the software image in the device for roll-back purpose.

In step 107, in some embodiments, the received software package is attempted to be installed in the first device to implement the update.

For example, the device may attempt to perform the installation based on the received software package after the one or more local portions of the software image has been stored in the device.

In step 107a, in some embodiments, the attempt to install the received software package is determined to be successful or not.

For example, the installation attempt may be considered to be successful if no errors or warnings or any malfunction occur at completion of the installation and if errors or warnings or any malfunction occurs then the installation attempt may be considered to be not successful.

In step 111, in some embodiments, successful installation is confirmed to the remote unit when the installation attempt of the software package succeeded (YES-path out of step 107a).

For example, a message may be sent to the remote unit via a host protocol that the installation attempt was successful.

In step 108, in some embodiments, the one or more second devices comprising the one or more remaining portion of the software image is authenticated by the first device when the attempt to install the received software package failed (NO-path out of step 107a).

For example, the one or more second devices comprising the one or more remaining portion of the software image are authenticated by the first device via an authentication protocol in order to verify that the correct second device is in communication with the first device for a request of the one or more remaining portion of the software image so that non-compatible or corrupt software/firmware/data is avoided.

In step 109, in some embodiments, the one or more remaining portion of the software image is requested by the first device from the one or more second devices comprising the one or more remaining portion of the software image when the authentication is successful.

For example, when the authentication has been successful the first device requests the one or more remaining portions of the software image from the authenticated second device comprising the one or more remaining portions of the software image via a host protocol or another protocol interconnecting the related devices, e.g. BLE or any wireless communication protocol or even a wired connection.

In some embodiments, the one or more remaining portion of the software image is requested from the one or more second devices in a sequential manner so that the one or more remaining portion are requested sequentially per second device from the plurality of devices or in a broadcasted manner so that the one or more remaining portion are requested from the one or more second devices at the same time from the plurality of devices.

For example, the one or more remaining portions of the software image may be requested sequentially i.e. via an individual request per second device or by a broadcasted request i.e. via one request to all related devices at the same time wherein the choice of sequential or broadcasted request depends on the type of connectivity amongst the related devices.

If no response to the request is received, then retrieval of the previous version fails. Redundancy can be increased if more than one device stores the same portion. If a certain portion cannot be retrieved from a second device, then the other second device(s) storing the same portion can be requested.

If no response to the request is received, then the request may be retransmitted a certain number of times. If no response is received, then retrieval of the previous version fails. Redundancy can be increased if more than one device stores the same portion. Hence, more than one second device may respond with the same portion and the first device will only store one of the responses for each portion of the software image of the previous version.

In step 110, in some embodiments, rollback to the software image based on the one or more local portions of the software image stored in the first device and one or more remaining portion of the software image is performed when the update fails by requesting the one or more remaining portion of the software image from one or more second devices of the plurality of devices and reinstalling a re-assembled software image in the first device.

For example, in case of errors/warnings/malfunction of the installed software package a rollback may be performed to restore the previous version. The rollback requires that all portions of the software image of the previous version to be re-assembled in the device which is to perform the rollback by requesting the one or more remaining portions of the software image of the previous version from the related devices. Once all portions of the software image of the previous version are obtained/received, the re-assembling of the software image of the previous version is completed and the previous version is reinstalled in the device.

In step 112, in some embodiments, fail and rollback is confirmed to the remote unit when the installation attempt of the software package failed and rollback was performed.

For example, a message may be sent to the remote unit via a host protocol that the installation attempt was not successful and that a rollback to the previous version was performed with the help of the related devices comprising one or more remaining portions of the software image of the previous version.

In some embodiments, at least one device of the plurality of devices is acting as a relay node for transmission of signals to and from at least one device of the plurality of devices.

For example, one device of the related devices may act as a relay node for transmitting a signal from the remote unit to the related devices comprising information about the one or more local portions of the software image to store.

In some embodiments, the at least one device of the plurality of devices comprises any one of an Internet of Things device, a sensor, and a WiFi hotspot.

In some embodiments, the devices in the distributed system communicate with each other over a short-range wireless communication protocol or a wired connection.

One or more of the above method steps may be iterated when an installation attempt has failed and a rollback has been performed.

Above selection of the group of devices, in step 101, may comprise selecting those devices wherein the installation attempt has failed and a rollback has been performed.

An advantage of some embodiments is that alternative approaches for remote update of devices are provided.

Another advantage of some embodiments is that when applying the resource-saving update approach, less memory capacity is required in a device for storing the previous version for roll-back purposes.

Yet an advantage of some embodiments is that, even if the size of the update, i.e. the software package to be installed, grows over time, the device can still manage the storing of the previous version for roll-back purposes without increasing the memory capacity of the device and more devices, if possible, may be involved in the storing of the previous version.

Yet another advantage of some embodiments is that a secure distributed system for memory usage is provided.

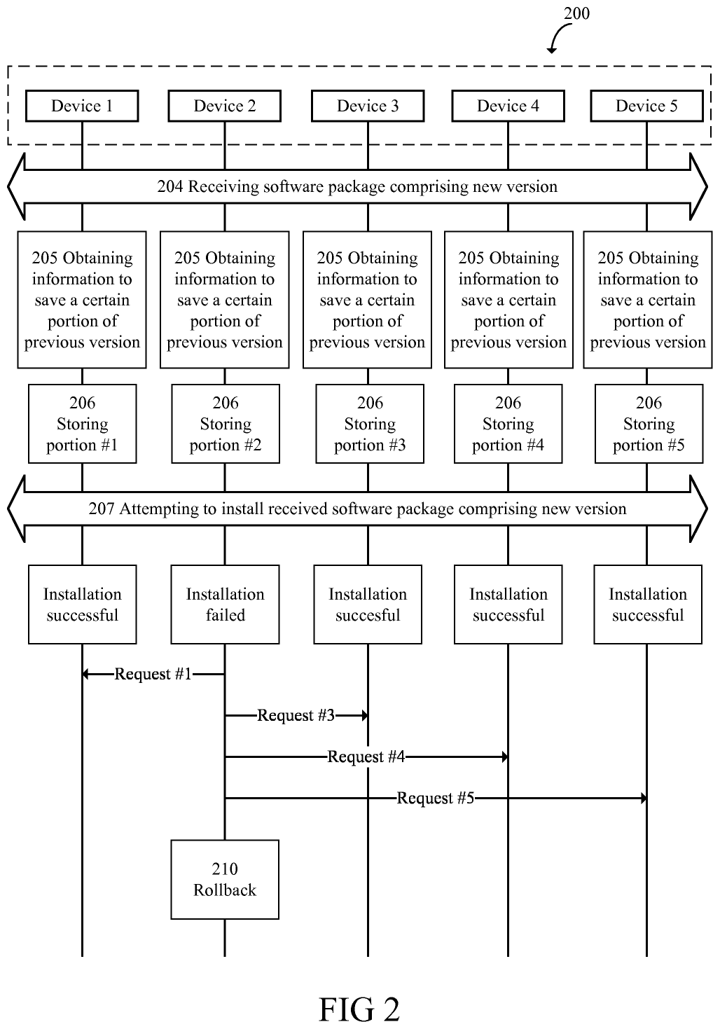

FIG. 2 is a sequence diagram illustrating signaling steps of an example signaling 200 according to some embodiments. The signaling 200 is for remotely updating a plurality of devices wherein the plurality of devices form a distributed system for memory usage.

Thus, the signaling 200 may, for example, be performed by the system 300 of FIG. 3 and/or the apparatuses 400 of FIG. 4 and/or the computer program product 500 of FIG. 5.

FIG. 2 illustrates a selected group of related devices, Devices 1-5, for a remote update wherein the devices form a distributed system for memory usage.

The signaling 200 comprises following steps.

In step 204, corresponding to step 104 of the method 100 illustrated in FIG. 1, a software package is received at each of the devices for an update from a remote unit.

In step 205, corresponding to step 105 of the method 100 illustrated in FIG. 1, information to store one or more local portions of a software image locally in each of the devices is obtained by the devices wherein the one or more local portions each comprises a defined portion of a current version of software executing in the devices.

In step 206, corresponding to step 106 of the method 100 illustrated in FIG. 1, the one or more local portions of the software image is stored in memory of each of the devices.

In step 207, corresponding to step 107 of the method 100 illustrated in FIG. 1, in some embodiments, the received software package is attempted to be installed in each of the devices to implement the update.

In step 210, corresponding to step 110 of the method 100 illustrated in FIG. 1, in some embodiments, rollback to the software image based on the one or more local portions of the software image stored in each of the devices and one or more remaining portion of the software image is performed when the update fails by requesting the one or more remaining portion of the software image from one or more second devices of the plurality of devices and reinstalling a re-assembled software image in the first device.

For Device 2 the installation attempt was not successful as the installation failed while for Devices 1, 3, 4, 5 the installation attempt was successful. For Device 2 a rollback to the software image of the previous image is performed by requesting the remaining portions of the software image, i.e. portions 1, 3, 4, 5, from the related Devices 1, 3, 4, 5 sequentially. Once all portions of the software image of the previous version have been obtained/received, the re-assembling of the software image is performed and the re-assembled software image is reinstalled in Device 2.

FIG. 3 is a schematic overview illustrating devices in an example system 300 according to some embodiments. The system 300 is for remotely updating a plurality of devices wherein the plurality of devices form a distributed system for memory usage.

Thus, the system 300 may, for example, perform the method steps described in connection with FIG. 1 and signaling steps described in connection with FIG. 2 or otherwise described herein.

FIG. 3 illustrates a selected group of related devices, Devices 1-5, for a remote update wherein the devices form a distributed system for memory usage.

The system 300 comprises a remote unit 310 and a selected group of related devices 320 further comprising “Device 1” 301, “Device 2” 302, “Device 3” 303, “Device 4” 304, and “Device 5” 305.

The system 300 is configured to remotely update the selected group of related devices 320.

A remote unit 310 sends a software package to each of the devices 301, 302, 303, 304, 305.

This may be preceded by a notification from the remote unit 310 to the selected group of devices 320 that a new version of the software/firmware/data is available or the devices 301, 302, 303, 304, 305 of the selected group of devices 320 may detect that a new version of the software/firmware/data is available. The update may be mandatory to accept, or the selected group of devices 320 comprising devices 301, 302, 303, 304, 305 may have the option to request the update at a later occasion.

Before installation of the received software package at each of the devices 301, 302, 303, 304, 305, the devices 301, 302, 303, 304, 305 obtain information on what portion(s) of the software image of the current version of software executing in the devices each device should store.

The obtainment of information on what portion(s) of the software image of the current version of software executing in the devices to store may comprise a pre-determined scheme, or a negotiation process between the remote unit and the devices or amongst the devices themselves or a pre-configuration in the devices.

For example, a pre-determined scheme may comprise each device storing an equal part of the software image where e.g. the lowest device ID stores the lowest memory part of the software image.

In case there is an error in the reception of the software package or if the device does not have the memory capacity to store the one or more local portions of the software image then the device is excluded from the group of related devices and a new group of related devices is selected.

Once one or more local portions of the software image is locally stored in each device an attempt to install the software package may be performed.

In case the installation attempt fails, the failing device will collect the one or more remaining portions of the software image for the previous version from the related devices to restore, i.e. reassemble and reinstall, the previous version.

The system 300 further illustrates the remote unit 310 being in communication with the selected group of related devices 320 utilizing e.g. a long-range wireless communications protocol via a transceiver type 1.

The related devices 301, 302, 303, 304, 305 may communicate with each other also utilizing e.g. a short-range wireless communications protocol or a wired connection via a transceiver type 2.

It may also be so that only one device of the related devices 301, 302, 303, 304, 305 also operates a long-range transceiver of transceiver type 1 and acts as a relay node for the other related devices only operating a short-range transceiver type 2.

FIG. 4 is a schematic block diagram illustrating example apparatuses according to some embodiments. The example apparatuses 410, corresponding to 310 of FIG. 3, 401b, corresponding to 301 of FIG. 3, 402b corresponding to 302 of FIG. 3, and 403b, corresponding to 303 of FIG. 3, are for remotely updating a plurality of devices wherein the plurality of devices form a distributed system for memory usage.

Thus, the apparatuses 410, 401, 402, and 403 may, for example, perform the method steps described in connection with FIG. 1 and signaling steps described in connection with FIG. 2 or otherwise described herein.

The apparatus 410 comprises device controlling circuitry (CNTR) 400, which may in turn, in some embodiments, comprise a receiving module (REC) 401, e.g. receiving circuitry or receiving module, configured to receive, a confirmation of successful or non-successful installation attempt of a software package from the apparatuses 411, 412, 413, and a transmitting module (TRANS) 402, e.g. transmitting circuitry or transmitting module, configured to transmit a signal to each of the apparatuses 411, 412, 413 of the group of apparatuses 411, 412, 413 comprising information about one or more local respective portion of the software image to be stored.

The CNTR 400 further comprises a storing module (MEM) 403, e.g. memory circuitry or memory module, configured to store one or more software packages and a processing module (PROC) 404, e.g. processing circuitry or processing module, configured to perform selection of a group of apparatuses 411, 412, 413 for an update wherein the apparatuses 411, 412, 413 in the group comprise a software image of a same current version of software executing in the apparatuses 411, 412, 413 and determination of one or more respective local portion of the software image for each of the apparatuses 411, 412, 413 of the group to store in memory.

The CNTR 400 furthermore comprises a transmitting module (TRANS) 402, e.g. transmitting circuitry or transmitting module, configured to transmit signals to each of the apparatuses 411, 412, 413 of the group comprising information about the local respective portion of the software image.

The apparatus 410 may even further comprise a transceiving module (TX/RX) 420, e.g. transceiving circuitry or transceiving module, configured to transceive, i.e. transmit and/or receive, signals comprising information to and from the apparatuses 411, 412, 413 over a long-range wireless communication protocol.

The apparatuses 411, 412, 413 each comprise device controlling circuitry (CNTR) 401b, 402b, 403b, which may in turn, each comprise a receiving module (REC) 401-1, 401-2, 401-3, e.g. receiving circuitry or receiving module, configured to receive a software package for an update from apparatus 410, and, in some embodiments, a transmitting module (TRANS) 402-1, 402-2, 402-3, e.g. transmitting circuitry or transmitting module, configured to transmit a confirmation of successful or non-successful installation attempt of a software package in the apparatuses 411, 412, 413 to the apparatus 410.

The CNTR 401b, 402b, 403b each further comprise a storing module (MEM) 403-1, 403-2, 403-3, e.g. memory circuitry or memory module, configured to store one or more local portions of the software image and an obtaining module (OBT) 404-1, 404-2, 404-3, e.g. obtaining circuitry or obtaining module, configured to obtain information to store one or more local portions of the software image locally in the apparatuses 411, 412, 413 wherein the one or more local portions each comprises a defined portion of a current version of software executing in the apparatuses 411, 412, 413.

The apparatuses 411, 412, 413 may each further comprise a transceiving module (TX/RX) 421, 422, 423, e.g. transceiving circuitry or transceiving module, configured to transceive, i.e. transmit and/or receive, signals comprising information to and from the apparatuses 410, 411, 412, 413 over a short-range and/or long-range wireless communication protocol.

The system 400 further illustrates the apparatus 410, i.e. the remote unit, being in communication with the apparatuses 411, 412, 413, i.e. the selected group of related devices, utilizing e.g. a long-range wireless communications protocol via a transceiver type adapted for long-range wireless communication protocol or a wired connection.

Further, the apparatuses 411, 412, 413, i.e. the selected group of related devices, may communicate with each other also utilizing e.g. a short-range wireless communications protocol via a transceiver type adapted for short-range wireless communication protocol or a wired connection.

It may also be so that only one apparatus of the apparatuses 411, 412, 413 also operates a long-range transceiver and acts as a relay node for the other apparatuses 411, 412, 413 only operating short-range transceivers.

Generally, when an arrangement is referred to herein, it is to be understood as a physical product; e.g., an apparatus. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus (such as a wireless communication device) comprising arrangements, circuitry, and/or logic according to any of the embodiments described herein. Alternatively or additionally, an electronic apparatus (such as a wireless communication device) may be configured to perform methods according to any of the embodiments described herein.

According to some embodiments, a computer program product comprises a computer readable medium such as, for example a universal serial bus (USB) memory, a plug-in card, an embedded drive or a read only memory (ROM). FIG. 5 illustrates an example computer readable medium in the form of a compact disc (CD) ROM 500. The computer readable medium has stored thereon a computer program comprising program instructions. The computer program is loadable into a data processor (PROC) 520, which may, for example, be comprised in a wireless communication device 510. When loaded into the data processing unit, the computer program may be stored in a memory (MEM) 530 associated with or comprised in the data-processing unit. According to some embodiments, the computer program may, when loaded into and run by the data processing unit, cause execution of method steps according to, for example, any of the method illustrated in FIG. 1 or signaling steps according to, for example, any of the signaling illustrated in FIG. 2 or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for remotely updating a plurality of devices wherein the plurality of devices form a distributed system for memory usage, the method comprising the following steps:
receiving, at a first device of the plurality of devices, a software package for an update from a remote unit,
obtaining, by the first device, information to store one or more local portions of a software image locally in the first device wherein the one or more local portions each comprises a defined portion of a current version of software executing in the first device, and
storing, in the first device, the one or more local portions of the software image in memory.

2. The method according to claim 1, further comprising the steps of:
performing an attempt to install the received software package in the first device to implement the update, and
when the update fails, performing rollback to the software image based on the one or more local portions of the software image stored in the first device and one or more remaining portion of the software image by requesting the one or more remaining portion of the software image from one or more second devices of the plurality of devices and reinstalling a re-assembled software image in the first device.

3. The method according to claim 2, further comprising the step of:
authenticating, by the first device, the one or more second devices comprising the one or more remaining portion of the software image.

4. The method according to claim 2, further comprising the step of:
requesting, by the first device, the one or more remaining portion of the software image from the one or more second devices comprising the one or more remaining portion of the software image when the authentication is successful.

5. The method according to claim 4, wherein the requesting of the one or more remaining portion of the software image from the one or more second devices may be sequential so that the one or more remaining portion are requested sequentially per second device from the plurality of devices or broadcasted so that the one or more remaining portion are requested from the one or more second devices at the same time from the plurality of devices.

6. The method according to claim 2, further comprising the steps of:
confirming successful installation to the remote unit when the installation attempt of the software package succeeded, or
confirming installation failure and rollback to the remote unit when the installation attempt of the software package failed and rollback was performed.

7. The method according to claim 1, wherein at least one device of the plurality of devices acts as a relay node for transmission of signals to and from at least one device of the plurality of devices.

8. The method according to claim 1, wherein the at least one device of the plurality of devices comprises any one of an Internet of Things device, a sensor, and a WiFi hotspot.

9. The method according to claim 1, wherein the devices in the distributed system communicate with each other over a short-range wireless communication protocol or a wired connection.

10. A method for remotely updating a plurality of devices wherein the plurality of devices form a distributed system for memory usage, the method comprising the following steps:
selecting a group of devices for an update wherein the devices in the group each comprise a software image of a same current version of software executing in the devices,
determining one or more local portions of the software image for a device of the group to store in memory,
transmitting a signal to the device comprising information about the one or more local portions of the software image to store, and
executing the determining and the transmitting steps for each device in the group of devices.

11. The method according to claim 10, wherein the selecting, determining, and transmitting steps are performed by a remote unit.

12. The method according to claim 10, wherein the selecting, determining and transmitting steps are performed by a device of the distributed system.

13. The method according to claim 10, wherein the selecting of the group of devices further comprises selecting devices of same or of different type comprising the same current version of software executing in the devices and wherein the devices are capable of communicating with each other.

14. The method according to claim 10, wherein the one or more local portions of the software image comprises a portion of a binary image installed in the memory of the device.

15. The method according to claim 14, wherein the portion of the binary image is a coherent or a non-coherent portion in memory.

16. The method according to claim 10, wherein the signal comprising information about the local portion of the software image to store further comprises information about the one or more remaining portion of the software image and their storage in the distributed system.

17. The method according to claim 10, wherein the determining of the local portion of the software image to be stored further comprises assessing available memory in each device of the distributed system.

18. The method according to claim 10, wherein the group of devices comprises at least two devices with the same current version of software executing in the devices and capable of communicating with each other.

19. The method according to claim 11, wherein the remote unit comprises a host or a host comprising a server.

20. The method according to claim 19, wherein the host and at least one device in the distributed system communicate with each other over a long-range wireless communication protocol or a wired connection.

21-42. (canceled)
